(19) United States
(12) Patent Application Publication
(10) Pub. No.: US 2025/0054088 A1
(43) Pub. Date: Feb. 13, 2025

(54) LAW ENFORCEMENT NETWORK PLATFORM

(71) Applicant: Law Enforcement Network, LLC, Miami, FL (US)

(72) Inventor: Hussein AbuHassan, Miami, FL (US)

(21) Appl. No.: 18/800,736

(22) Filed: Aug. 12, 2024

Related U.S. Application Data
(60) Provisional application No. 63/531,906, filed on Aug. 10, 2023.

(51) Int. Cl. G06Q 50/26; G06V 10/82; G06V 20/52

(52) U.S. Cl. CPC G06Q 50/265; G06V 10/82; G06V 20/52

(57) ABSTRACT

An emergency response system that can share at least near real time information for response coordination and at least responder and citizen notifications. A neural network can be trained on historical data to identify characteristics associated with one or more trigger events that can relate to a variety of potentially dangerous situations. A trigger event can also arise in response to receipt of a reported violation from a citizen, including based on a violation type selected by the citizen using a user interface. Optionally, information regarding a trigger event can be communicated to a supervisory communication device for a supervisory decision as to whether responders are to be deployed to address the trigger event. Further, responders located within a certain distance of the trigger event, and having a specialty relating to the type of trigger event, can receive a request to attend to the trigger event.

### TECHNICAL FIELD

The present disclosure generally relates to an emergency response system, and more particularly, but not exclusively, to an emergency response system that shares at least near real time information for response coordination and at least responder and citizen notifications.

### BACKGROUND

Traditionally, first responders responding to a citizen's request for assistance may arrive at a requested location with little, if any, specific information regarding the nature of the request or corresponding circumstances. Additionally, during the course of time that may lapse between the citizen's request and the arrival of the first responders, the nature or circumstances associated with the request can have changed or otherwise developed in different manners without the responders' knowledge. Such changes can create potentially dangerous, including life threatening, situations for the responders. Additionally, often a citizen's request can provide insufficient information with respect to which, and where, responders are to at least initially be deployed to address the associated situation. For example, in the haste of a moment, information provided by citizen's request may be insufficient to determine whether police officers or a special weapons and tactics (SWAT) team is to be deployed to assist the citizen, let alone other details regarding a point(s) of entry for such responders into a potentially dangerous environment.

### SUMMARY

The present disclosure may comprise one or more of the following features and combinations thereof.

In one embodiment of the present disclosure, an emergency response system is provided that can include one or more databases that receive a neural network training data corresponding to a plurality of characteristics for each of a plurality of historical trigger conditions. The emergency response system can also include at least one processor and a memory device coupled to the at least one processor. The memory device can include instructions that when executed by the at least one processor cause the at least one processor to analyze, for continuous training of a neural network based on machine learning, the neural network training data to identify one or more trigger event characteristics corresponding to one or more of the plurality of historical trigger conditions, and detect, using the neural network, an occurrence of a trigger event based at least on a detection of the one or more trigger event characteristics in one or more captured images. Additionally, the memory device can further include instructions that when executed by the at least one processor cause the at least one processor to generate, in response to the detection of the one or more trigger event characteristics, a signal to communicate the detection of the trigger event to at least one supervisory communication device, and generate, after communication of the detection of the trigger event to at least one supervisory communication device and in response to a receipt of an approval signal from the at least one supervisory communication device, a notification to at least one responder communication device, the approval signal having an indication of an approval by a supervisor of at least one responder being deployed to respond to the trigger event.

In another embodiment, a method is provided for operating an emergency response system. The method can include receiving a report signal that identifies a reported violation being reported via use of a citizen communication device of a citizen. The report signal can identify, for the reported violation, at least a violation location and a violation type. A plurality of responders to respond to the reported violation can be identified, each responder of the plurality of responders being identified based at least on a responder location identified for the responder being within a predetermined distance from the violation location and an identified specialty of the responder corresponding to the violation type. A response signal can be received from a responder communication device of at least one responder of the plurality of responders. The response signal can indicate an agreement of the at least one responder to respond to the reported violation. Additionally, based at least on the violation type, a query signal can be generated to communicate to the citizen communication device a plurality of predefined questions and, for each predefined question, a plurality of predefined answers. Further, a signal can be generated to communicate to the responder communication device of the at least one responder a predefined answer from the plurality of predefined answers selected by the citizen to at least one predefined question of the plurality of predefined questions.

In another embodiment, a method is provided for operating an emergency response system. The method can include analyzing, for continuous training of a neural network based on machine learning, a neural network training data to identify one or more trigger event characteristics corresponding to one or more of a plurality of historical trigger conditions. Additionally, the method can include detecting, using the neural network, an occurrence of a trigger event based at least on a detection of the one or more trigger event characteristics in one or more captured images. Further, in response to the detection of the one or more trigger event characteristics, a signal can be generated to communicate the detection of the trigger event to at least one supervisory communication device. After communication of the detection of the trigger event to at least one supervisory communication device, and in response to a receipt of an approval signal from the at least one supervisory communication device, a notification can be generated to at least one responder communication device, the approval signal indicating of an approval by a supervisor of at least one responder being deployed to respond to the trigger event.

These and other features of the present disclosure will become more apparent from the following description of the illustrative embodiments.

### BRIEF DESCRIPTION OF THE FIGURES

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a simplified block diagram of an exemplary emergency response system.

FIG. 2 illustrates an exemplary display of a three-dimensional model, as generated via use of the emergency response system, of a floor of a building in which a trigger event has been detected by the emergency response system.

FIG. 3 illustrates an exemplary display of a three-dimensional model, as generated via use of the emergency response system, of a collection of buildings within an identified location, as well as identification labels for at least some of the depicted buildings.

FIG. 4 illustrates a simplified exemplary representation of a method for an operation of the emergency response system in response to a detection of a trigger event by the emergency response system.

FIG. 5 illustrates a portion of the floor shown in FIG. 3 at a location on the floor where an individual detected as being associated with the trigger event is currently located.

FIG. 6 illustrates a portion of the floor shown in FIG. 3 in which an image of an individual and associated object involved in the detected trigger event is overlaid over a portion of the three-dimensional model.

FIG. 7 illustrates a portion of the floor shown in FIG. 3 at an area corresponding to a location of the detected trigger event.

FIG. 8 illustrates a simplified exemplary representation of a method for an operation of the emergency response system in response to a citizen communicating information reporting a violation.

FIG. 9A illustrates an exemplary first graphical user interface providing various violation types available for selection by a citizen via use of a citizen communication device.

FIG. 9B illustrates an exemplary second graphical user interface providing various sub-violation types available for selection by a citizen via use of a citizen communication device.

FIG. 10 illustrates a simplified exemplary representation of another embodiment of a method for an operation of the emergency response system in response to a citizen communicating information reporting a violation.

### DETAILED DESCRIPTION OF THE ILLUSTRATIVE EMBODIMENTS

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

In the Detailed Description herein, references to “one embodiment”, an “embodiment”, and “example embodiment”, etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

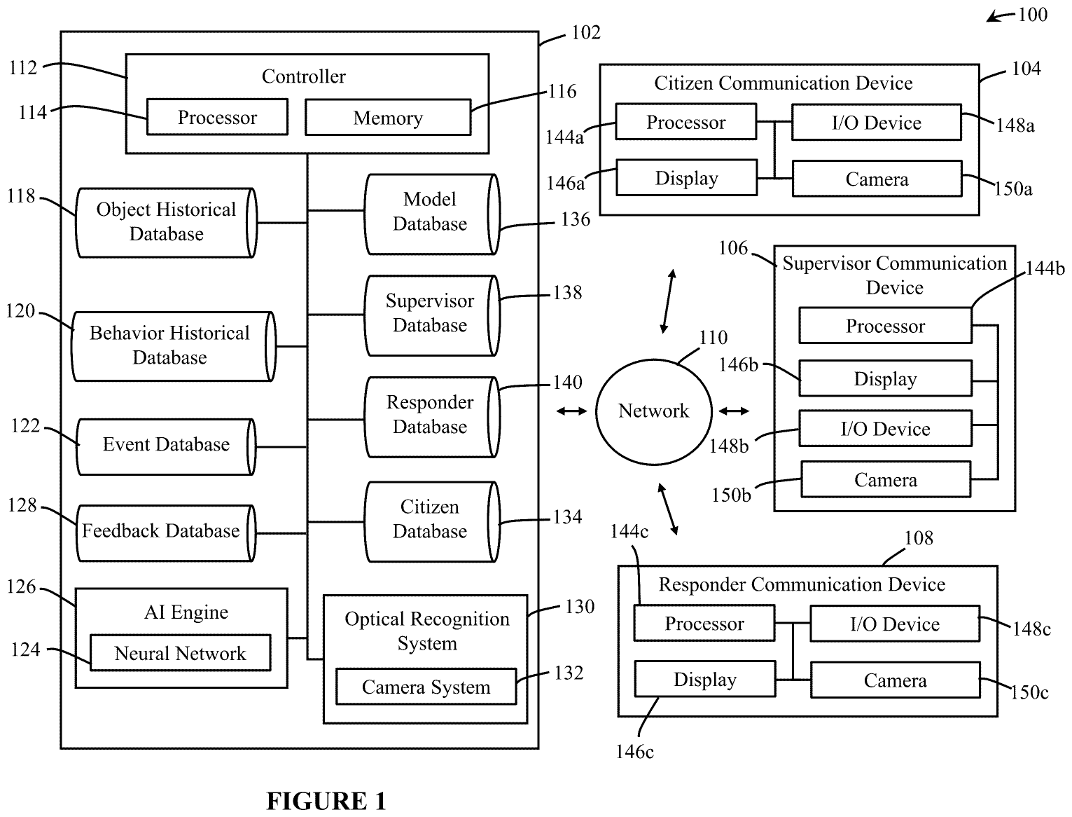

FIG. 1 illustrates a simplified block diagram of an exemplary emergency response system 100. As illustrated, the response system 100 can include at least a response platform 102, a plurality of citizen or client communication devices 104, a plurality of supervisor communication device 106, and a plurality of responder communication devices 108. Each of the citizen, supervisor, and responder communication devices 104, 106, 108 can be computing devices, including, but not limited to, a personal and or mobile computing device, including, for example, the personal computer, laptop, smartphone, mobile phone, and/or tablet, among other computing devices. Further, at least the response platform 102 can communicate with each of the citizen, supervisor, and responder communication devices 104, 106, 108 in a variety of different manners, including, for example, via a wired and/or wireless network 110. Thus, at least some, if not all, of the citizen, supervisor, and responder communication devices 104, 106, 108 can include at least a processor 144a-c, display 146a-c, and input/output (I/O) device 148a-c. Further, the display 146a-c may or may not be part of the I/O device 148a-146c. Moreover, the I/O device 146a-c may be, for example, a keyboard, keypad, touch screen, mouse, microphone, speaker, button, switch, or joystick, as well as various combinations thereof, among other I/O devices. Additionally, at least the citizen communication device 104 can include a camera 150a that can capture one or more captured images, also referred to herein as captured information, including, but not limited to, photographs, still images, video and/or video frames, that can be communicated to the response platform 102, as discussed below. However, according to certain embodiments, either or both of the supervisor and responder communication devices 106, 108 can also include a camera 150b, 150c.

The response platform 102 can include a controller 112 having at least one processor 114 coupled to at least one memory device 116. The processors 114 can be embodied as any type of processor or other compute circuit capable of performing various tasks such as, for example, in connection with generating, analyzing, and facilitating the communication of information in association with various aspect of the response network system 100 and/or the response platform 102. In some embodiments, each processor 114 can be embodied as a single or multi-core processor, a microcontroller, or other processing or controlling circuit. Additionally, in some embodiments, each processor 114 may be embodied as, include, or be coupled to an FPGA, an application specific integrated circuit (ASIC), reconfigurable hardware or hardware circuitry, or other specialized hardware to facilitate performance of the functions described herein. In some embodiments still, each processor 114 can be embodied as a high-power processor, an accelerator co-processor, an FPGA, or a storage controller.

Each memory device 116 can be embodied as any type of volatile (e.g., dynamic random-access memory (DRAM), etc.) or non-volatile memory capable of storing data therein. Volatile memory can be embodied as a storage medium that requires power to maintain the state of data stored by the medium. Non-limiting examples of volatile memory can include various types of random-access memory (RAM), such as dynamic random-access memory (DRAM) or static random-access memory (SRAM). In some embodiments, each memory device 116 can be embodied as a block addressable memory, such as those based on NAND or NOR technologies. Each memory device 116 can also include future generation nonvolatile devices or other byte addressable write-in-place nonvolatile memory devices. Additionally, in some embodiments, each memory device 116 can be embodied, or otherwise include, a memory device that uses chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. Each memory device 116 can refer to the device itself or to a packaged memory product. In some embodiments still, 3D crosspoint memory can comprise a transistor-less stackable cross point architecture in which memory cells sit at the intersection of word lines and bit lines and are individually addressable and in which bit storage is based on a change in bulk resistance. In some embodiments yet still, all or a portion of each memory device 116 can be integrated into the processor(s) 114. Regardless, each memory device 116 can store various software and data used during operation such as task request data, kernel map data, telemetry data, applications, programs, libraries, and drivers. Thus, the memory devices 116 can include information, including, but not limited to, algorithms and look-up tables, among other information, that can used by the processor 114.

The response platform 102 can further include one or more databases 118, 120, 122 containing neural network training data used to train a neural network 124 of and artificial intelligence (AI) engine) 126. For example, the response platform 102 can include an object historical database 118 that includes neural network training data, including, for example, actual and/or synthetic data that can include identified or known objects in the form or weapons, such as, for example, firearms and knives, among other weapons, in images and/or video, among other data that can be used for training the neural network 124, and, moreover, for the training and retaining of any associated models, including algorithms.

Additionally, the response platform 102 can include a behavior historical database 118 that can include neural network training data that can be used to train the neural network 122 to identify certain behaviors of individuals or groups of individuals that may be engaged in unlawful activities and/or activities deemed to be potentially, if not actually, dangerous to those individuals or to other individuals. For example, according to certain embodiments, multiple sequences of images provided by historical captured information, among other historical information, in addition to, or in lieu of, similar information being obtained and analyzed in at least near real time, can be analyzed for detection of different types of human behavior. Such a training process can therefore be more is distinct and complex than training of the neural network 122 for object detection. Further, according to certain embodiments, the responsive platform 102 can include an event database 122 that can include neural network training data in the form of, but not limited to, images and or videos, that can be used to train the neural network 122 to identify and/or detect particular types of potentially dangerous events, including, for example, events relating to the presence of a fire(s), flooding, and damage to doors and/or windows that may be associated with unauthorized forceful entries, among other events.

The response platform 102 can further include one or more feedback databases 128 that can provide neural network training data in the form of feedback information regarding prior determinations made by response platform 102 that can be utilized for further refinement of the models or algorithms developed by the neural network 124, and/or for training or retraining of the neural network 124. For example, the feedback database 128 can include information regarding prior determinations by the platform system 102 using one or more models developed by the neural network 124, and an associated decision by a supervisor regarding such determinations and or any subsequent actions performed by one or more responders and response to such determinations by the platform system 102.

The response platform 102 can further include an optical recognition system 130 that can receive information from a camera system 132 that can include a plurality of cameras. As discussed below, the cameras can be position at a variety of different locations, including, but not limited to, plurality of rooms, floors, hallways, staircases, patios, restaurants, and/or elevators, among other locations in, at, or around, a building or residence of one or more citizens. The optical recognition system 130 can be configured to utilize one or more models generated by the neural network 124 in connection with identifying one or more of an object, behavior, or event that may constitute a detection of a trigger event, as discussed further below.

The response platform 102 can further include a citizen database 134 that can store a variety of different information regarding citizens of, or that may otherwise utilize, the emergency response system 100. The type of information retained in the citizen database 134 can depend on the type of citizen, including, for example, whether the citizen is an individual, family, entity, or business, among other types of citizens. For example, according to certain embodiments, the citizen database 134 can store citizen information such as, for example, a citizen name, contact information (e.g., email address, phone number, address, etc.), and/or login information, including for example, citizen names and/or password(s) for accessing the emergency response system 100, among other information that may be utilized to at least register the citizen with the emergency response system 100. Optionally, the citizen database 134 can also include personal information regarding the citizen including, for example, known or existing health conditions, emergency contacts, family members, and/or related persons.

The response platform 102 can also include a supervisor database 138 that can correspond to individuals, and their associated supervisor communication device 106, that may perform at least supervisory review, including preliminary or gatekeeping review, of detected trigger events. As discussed below, a supervisor can review at least a trigger event detected by the response platform 102, including a trigger event based on a particular object, behavior, and/or event captured in one or more images and identified by the response platform 102 using one or more models developed using the neural network 126. Additionally, or alternatively, the detected trigger event can correspond to a communication received by the response platform 102 from a citizen communication device 104 reporting of an occurrence of a violation, also refer to herein as a violation type. Such review by the supervisor of the trigger event can be determinative with respect to whether a response is to be provided by responders to the trigger event, as well as to whether citizens are to be notified of the detected trigger event.

The supervisor database 138 therefore can include an identification of a specialized area for each of a plurality of supervisors, including with respect to one or more particular types of trigger events. Thus, for example, the supervisor database 138 can include an indication of whether each of the supervisors have a specificality associated with, for example trigger events that may involve law enforcement, firefighters, and/or emergency medical technicians, among other types of specialties. Alternatively, or optionally, the supervisor database 138 can further include location information associated with each potential supervisor so that a supervisor in, or assigned to, a location at which a trigger event is detected is contacted for the preliminary review of the detected trigger event. As another option, or alternative, the supervisor database 138 can include information regarding a current, or last know, location of a supervisor, including, for example, based on last known location information obtained by the response platform 102 from a location feature provided on at least the supervisor communication devices. According to such alternative, or optional, embodiments, such location information can be at least one factor used by the response platform 102 in identifying potential supervisors on the bases of a current location or proximity to the detected trigger event. Additionally, the supervisor database 138 can also include contact information for each supervisor, including, for example, contact information used to communicate information regarding the detected trigger event via the response platform 102 the particular supervisor communication device 106 of that identified supervisor.

The response platform 102 can also include a responder database 140 that can include at least contact information for one or more potential responders for various types of detected trigger events. Additionally, or alternatively, the responder database 140 can include information regarding one or more public and/or private dispatchers that can be notified of a detected trigger event, and/or of a detected trigger event after response platform 102 has received an approval notification from a supervisor, as discussed below. Moreover, as discussed further below, in response to a supervisor determining that a response by responders is to be provided to a detected trigger event, the response platform 102 can identify one or more responders, including, one or more responder agencies, that is/are to be notified of the detected trigger event. The responder(s) identified for notification of the detected trigger event can be based on a variety of different criteria, including, for example, the type of detected trigger event and the location of the trigger event relative to the location of, or assigned to, the responders.

A variety of different types of responders can be identified by responder database 140, or otherwise in operative communication with the emergency response platform. For example, according to certain embodiments, the responders can comprise public responders, employees, including for, example, responders that may be employed by local, state, and/or federal government or agencies, including, for example, fire fighters, police officers, paramedics, and/or SWAT teams, among others. Additionally, or alternatively, the responders can include private responders, including privately owned responder companies, security companies, and/or contractors, as well as their associated employees. According to certain embodiments, the responder database 140 can include information relating to both public and private responders. Additionally, or alternatively, systems used by private responders, such as, for example, cloud-based systems of such private responders or their associated private companies or entities, can be integrated with the emergency response system 100. Such incorporation of the systems of such private entities with the emergency response system 100 can accommodate the emergency response system 100 providing at least near real time data regarding a detected trigger event to either, or both, public and private responders, as well as updated information regarding such detected trigger events in at least near real time.

According to certain embodiments, the response platform 102 can also include a model database 136 that can store three-dimensional models of one or more interior and/or exterior portions of citizens' building, facilities, workplaces, and/or residences, among other locations. The model database 136 can also store, and the platform system 102 can used, a variety of different types of three-dimensional models, including, for example, computer generated three-dimensional models, models developed using images from stereo cameras, and/or three-dimensional models created via image stitching, among other techniques. For example, with respect to citizens having multi-floor buildings, or that occupy at least portions of one or more floors of a building, the model database can store a previously developed three-dimensional models of one or more, if not all, of those floors, as well as portions, thereof, as well as of associated stairwells, among other building structures or features, both inside and outside the vicinity of a particular building or structure.

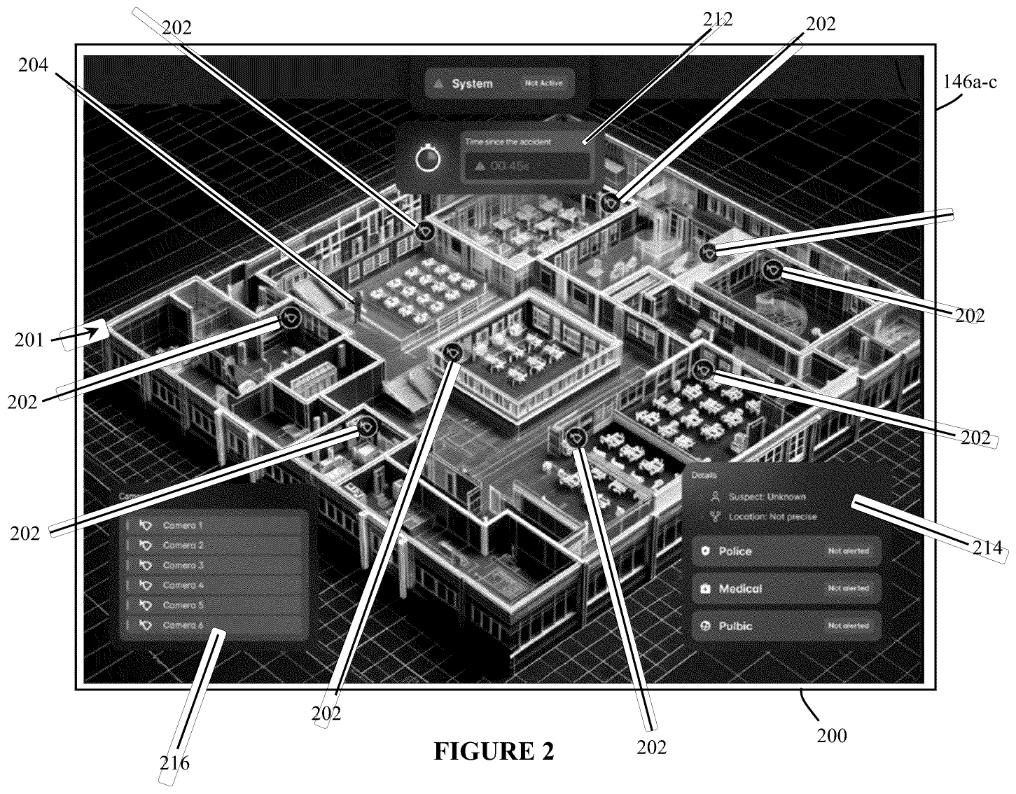

For example, at least FIG. 2 illustrates an example of a display of a digitally generated three-dimensional model 201 of one floor of a building that can be displayed on one or more displays 146a-c. As shown, the illustrated generated three-dimensional model depicts a plurality of rooms, hallways, common areas, and stairwells, among other information pertaining to the depicted floor. Additionally, in the illustrated example, the model 201 can further identify the locations of one or more of a plurality of cameras 202 of the camera system 132. As also seen in FIG. 2, different rooms can have different collections of furniture, as well as arrangements of furniture, that can, according to certain embodiments, also be depicted in the three-dimensional model 201.

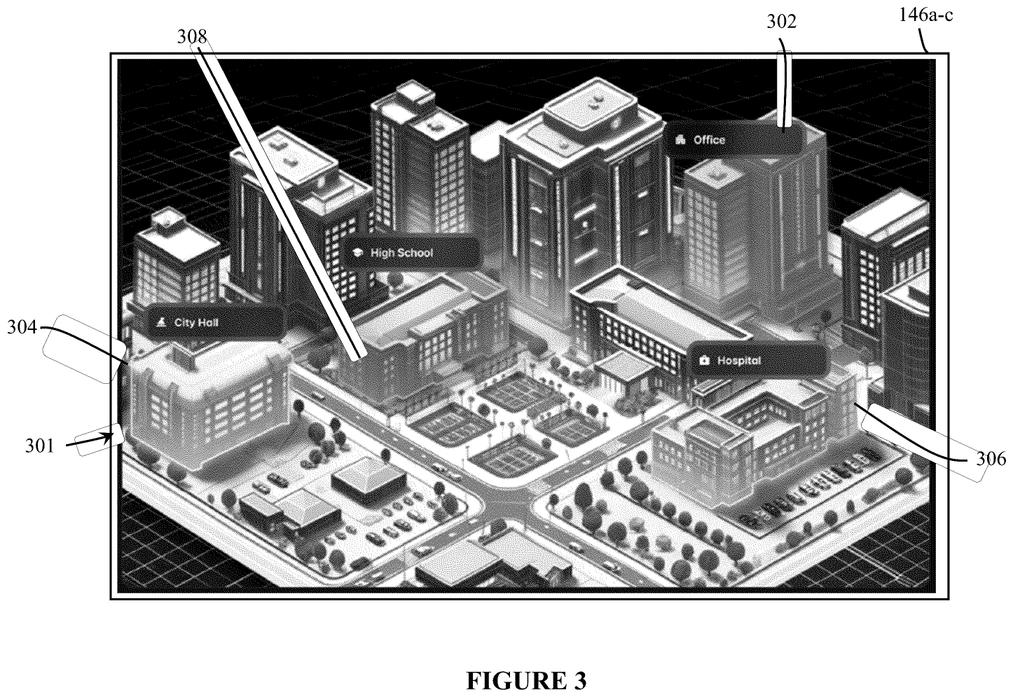

As seen by at least FIG. 3, the model database 136 can also include one or more three-dimensional models 301 for a display on one or more displays 146a-c of an area(s) around a particular location at which a triggered event may be detected. Moreover, as shown by the example illustrated in FIG. 3, the model database 136 can include a three-dimensional model 301 of one or more city blocks, and the associated buildings, parking lots, streets, and/or sidewalks, among other features, that can provide an actual, or realistic, depiction or rendering of a surrounding area. Further, the displayed three-dimensional model 301 can also include a plurality of different types of identification information including, with respect to, addresses, street names, business names, building names, and/or associated types of activities. For example, in the exemplary embodiment shown in FIG. 3, the displayed model 301 can include identifiers with respect to building types, including, but not limited to, text labels that indicate the location of an office 302, City Hall 304, hospital 306, and high school 308, among other types of identifiers. According to certain embodiments, such an area layout as displayed, for example, by the three-dimensional model 301 shown in FIG. 3, can be utilized to identify any location of a trigger event in connection with facilitating the deployment of first responders, as well as in connection with providing citizens, as may be identified by the citizen database 134, a notification of a location(s) of a potentially hazardous situation. For example, as discussed below, a model similar to that shown in FIG. 3 can be communicated by the response platform 102 to one or more citizen communication devices 104, supervisor communication devices 106, and/or responder communication devices 108 and can include a visual identifier, including, for example, an identifier in text and/or graphical format, identifying the location of a potentially hazardous situation.

The three-dimensional models 201, 301 provided by the model database 136 can be generated in a variety of different manners. For example, according to certain embodiments, the cameras 202 of the camera system 132 can be stereo cameras which can be used, either individually or collectively, to create a three-dimensional model of one or more areas of an area of interest. Additionally, or alternatively, different types of cameras 202 can capture information that, via use of image stitching or other approaches, can be utilized to generate a three-dimensional model. According to other embodiments, cameras or other image capturing devices, including, but not limited to, drones, can be at least temporarily provided to an interior and/or exterior area of interest to capture images that can then be used to generate the three-dimensional models. Further, according to certain embodiments, the three-dimensional models 201, 301 can be created using blueprints or other identifiers of an associated area or structure.

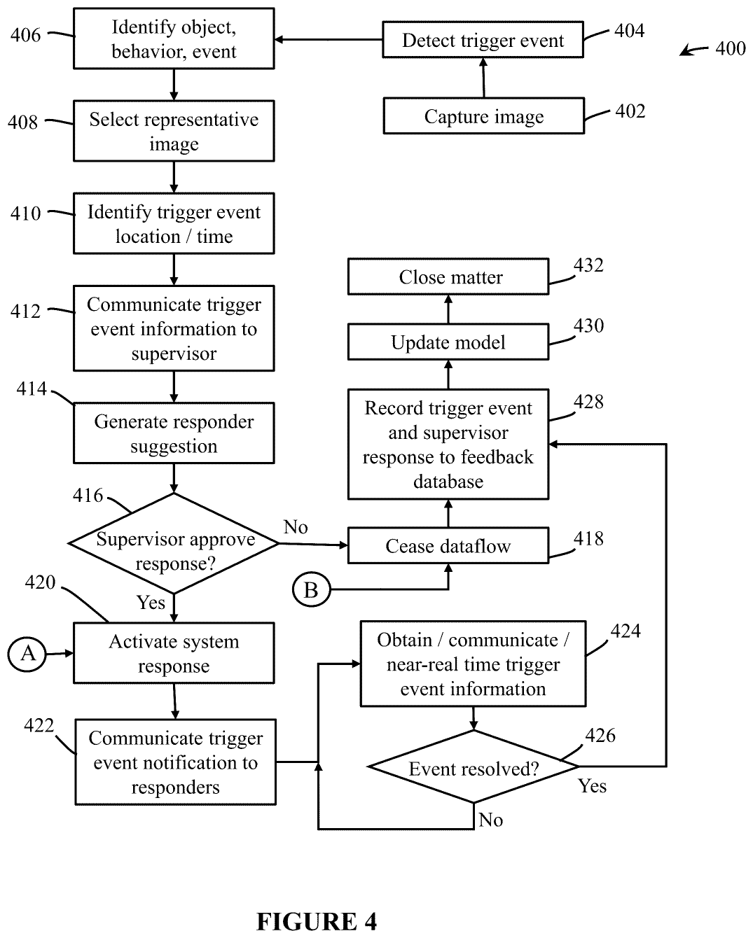

FIG. 4 illustrates a simplified exemplary representation of a method 400 for an operation of the emergency response system 100 in response to a detection of a trigger event by the emergency response system 100 and/or the response platform 102. The method 400 corresponds to, or is otherwise associated with, performance of the illustrative sequence shown in, and described in connection with, FIG. 4, and can be carried out, for example, by the exemplary emergency response system 100 shown in FIG. 1, including, for example, via use of one or more of the processors 114, 144a, 144b, 144c executing instructions stored on one or more associated memory devices 116. It should be appreciated, however, that the method 400 can be performed in one or more sequences different from the illustrative sequence. Additionally, the method 400 mentioned below can include steps or processes other than, or in addition to, those discussed below.

At block 402, one or more cameras 202 of the optical recognition system 130 can capture one or more images, including, for example, photographs and/or video, of an area, such as, for example, a portion of the floor in an interior area of a building, such as, for example, that depicted in FIG. 2, and/or a portion of an exterior area, such as, that, for example, shown in FIG. 3. According to certain embodiments, the one or more cameras 202 may, or may not, be continuously activated. For example, with respect to at least certain privacy concerns, a camera 202 can be at least temporarily activated in response to a detection of a movement, among other triggers, before subsequently being deactivated.

The optical recognition system 130, or other portion of the response platform 102, can apply one more models, including, for example, one or more algorithms, developed via use of the neural network 124 to the captured image from block 402 to identify whether a trigger event is detected within the captured image. As discussed with respect to at least FIG. 1, the model, which may be a deep learning model, can be trained and/or retrained, to detect a variety of different features that may correspond to a trigger event. For example, according to certain embodiments, and as previously discussed, the model used by the optical recognition system 130, or used by other portions of the response platform 102, can be trained to identify one or more characteristics from a plurality of characteristics in a captured image, such as presence of a weapon, among other particular objects that may, or may not, correspond to a presence of a weapon in the image captured at block 402. Additionally, or alternatively, as previously discussed, the model can be trained to identify one or more characteristics from the training data corresponding to different types of behavior, including, human behavior. For example, according to certain embodiments, the model can be trained to identify characteristics associated with particular types of human behavior, as distinguish potentially harmful or dangerous characteristics from characteristics that are not associated with harmful or dangerous behavior. Moreover, such training of the neural network 124 can include identifying behavior that might be associated with an assault, battery, robbery, theft, violence, accident, and/or medical or mental emergency, among other human behaviors, as well as combinations thereof. Additionally, or alternatively, the model can, as also discussed above, be trained to identify the presence, or non-presence, of particular events, including, for example, the presence of fire, smoke, and or flooding, among other events.

According to certain embodiments, the response platform 102, including, for example, the optical recognition system 130, can identify a detection of a trigger event using one or more trained models based on a generated confidence rate for at least a portion of the captured information. The confidence rate can correspond to a likelihood or probability that captured information, including one or more video frames, has information representing a particular object (e.g., weapon), behavior, and/or event. In such instances, upon at least a portion of the captured information obtaining a score for the confidence rate that satisfies a predetermined threshold, the response platform 102 can determine there is sufficient likelihood of a presence of a trigger event in the captured information. According to certain embodiments, in response to the score for the confidence rate satisfying the predetermined threshold, the platform can proceed generating a notification signal for one or more of a supervisor (block 414), responder (422), and/or a dispatcher who contacts responders or associated responder agencies.

Optionally, at block 406, the response platform 102, including, for example, the optical recognition system 130, can provide an identification of the object, behavior, and/or event that was detected at block 404. Such an identification at block 406 can include a textual identification and/or description of the trigger event detected at block 404.

Additionally, and optionally, the response platform 102, including, for example, the optical recognition system 130, can, at block 408, identify, or select a portion of, an image, or portion of an image, from the information captured at block 402 to be a representative image. For example, at block 408 the response platform 102 can select one or more photographs, videos, video, and/or videos frames, as well as portions thereof, that are associated with the identified trigger event that was detected at block 404 to be a representative image.

The determination, if any, of which portion of the image that was captured at block 402 that is to be selected as the representative image can be based on a variety of criteria. For example, according to certain embodiments, the representative image can correspond to the captured information from block 404 that was determined to have the highest score in terms of the confidence rate. However, additional criteria can also be included in the decision of which portion of the captured image from block 402 is to be selected as the representative image at block 408. For example, according to certain embodiments, the system platform 102 can be configured to also consider, in determining a representative image, the extent at least a portion of the captured information contains information sufficient for an identification or recognition of one or more individuals associated with the detected trigger event. Thus, for example, the representative image selected at block 408 may be determined based on a combination of the score of the image in terms of the confidence rate and the ability to detection of facial features of a person identified as being associated with the trigger event.

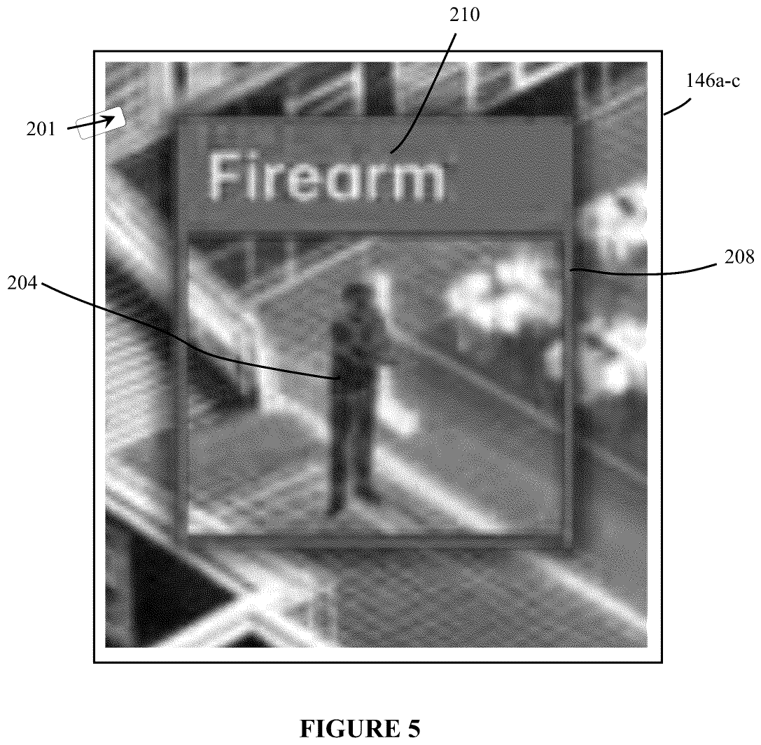

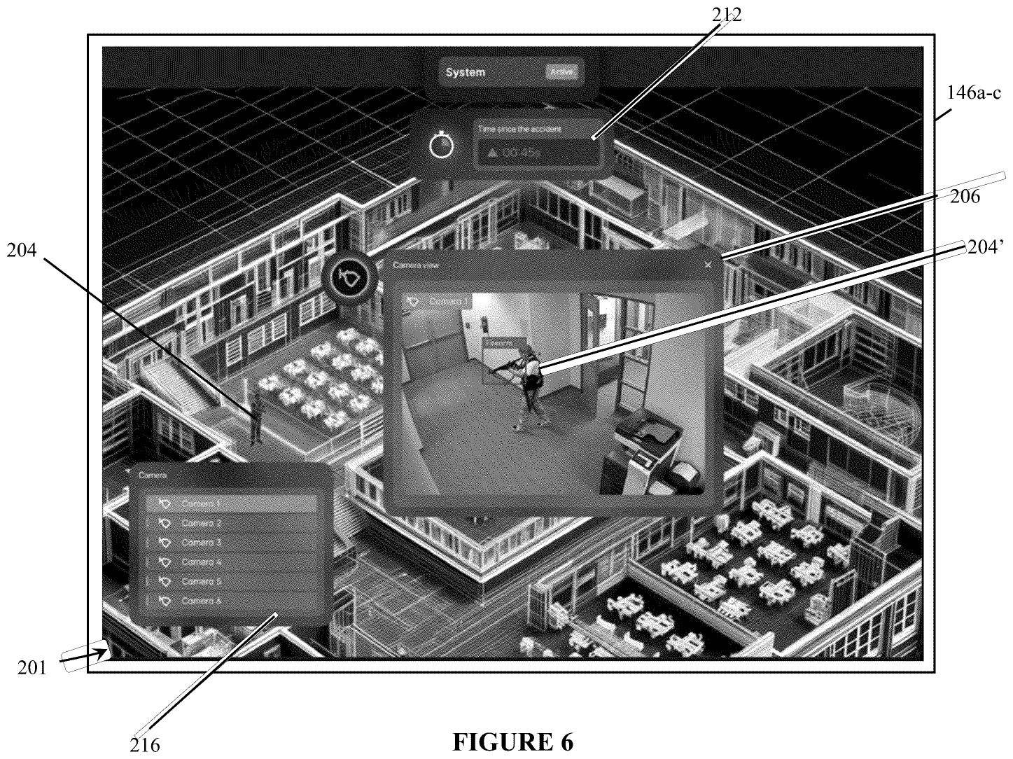

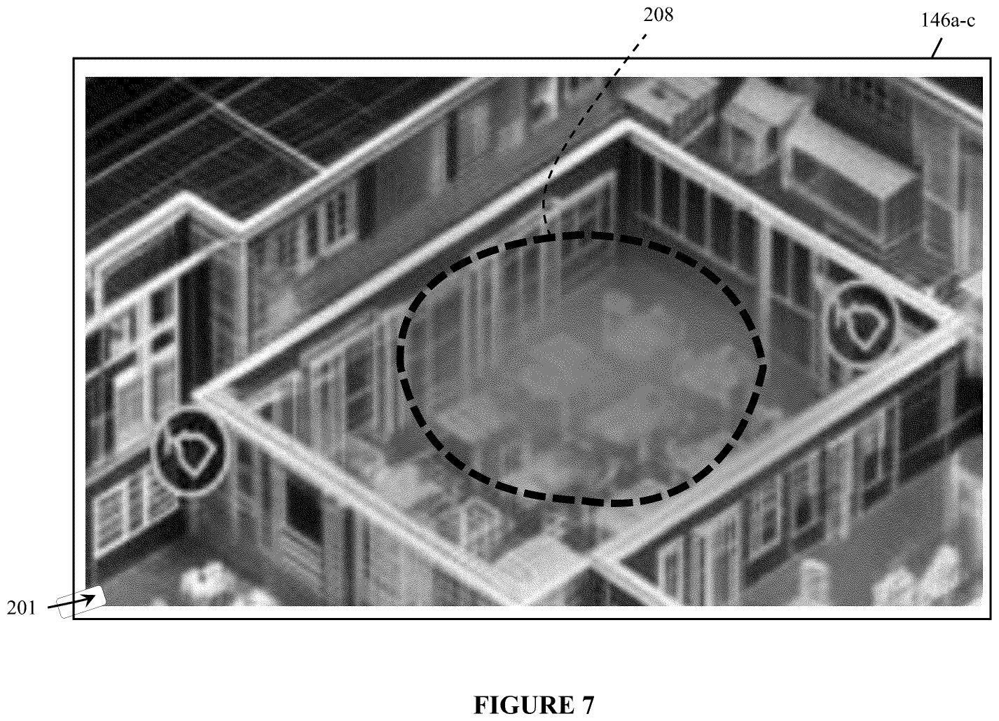

As seen by FIG. 6, according to certain embodiments, an actual image 206, including photograph and/or video, of the detected trigger event can be overlaid, or otherwise provided in connection with, the three-dimensional model 201 of the area at issue. Thus, in the example shown in FIG. 6, the three-dimensional model of the interior area at which the trigger event has been detected can be generated to include an indication of a location of the trigger event. According to such an embodiment, the location at which the individual 204 is presently located, including the location at which the individual 204 is moving or has moved to, can be represented in the three-dimensional model 201 at least in near real time. Additionally, or alternatively, as illustrated by FIGS. 5 and 7, an area in which the triggered event was detected, and/or associated individual(s) or event have been and/or are currently located, can also be graphically identified in other manners, including, for example, via insertion of a boundary 208, symbols, text 210, and/or markers, among other manners. Additionally, the confidence rating, as discussed above, with respect to the likelihood of trigger event being detected, can also be included in the information provided by the display. Thus, in addition to being able to identify the location at which a trigger event occurred, the response platform 102 can provide, in at least near real time, information, indicating, in a variety of manners, a current position of an individual(s) that is involved with, or contributed to, the detected trigger event.

For example, at least FIGS. 2, 3, 5, and 6 provide an illustrative example involving an individual 204′ possessing a firearm on a floor of a building that can be shown in one or more three-dimensional models 201, 301. Accordingly, the platform system 102 can identify, at block 401, a building address associated with at least the camera system 132 capturing information regarding the trigger event, the floor at which the trigger event occurred/is occurring, and a current or updated location, in near real time, of the trigger event or associated individual(s). Additionally, the platform system 102 can be configured to overlay certain information on the displayed three-dimensional models 201, 301, including, for example, and identification of the type of detected trigger event (e.g., a detection of a “firearm”). Additionally, as seen in at least FIG. 6, the platform system 102 can also be configured to overlay a captured image obtained at block 402 and/or updated or current image, in near real-time, of the trigger event or associated individual. Thus, for example, the image overlaid over the model 201 in FIG. 6 can provide an image obtained at block 402 and/or a current image, in near-real time, of the individual 204′ associated with the trigger event, which in this event may be an individual possessing a detected firearm.

At block 412, the response platform 102 can communicate at least information from one or more, if not all, of blocks 406, 408, 410, or an associated notification of the availability of such information, to one or more supervisor communication devices 106. The particular supervisor communication device(s) 106, and thus the associated supervisor(s), that is/are to receive the communication at block 412 can be based on a variety of criteria. For example, as previously discussed, the response platform 102 can include one or more supervisor databases 138, which can include, among other information, information regarding an area and/or location at which the associated supervisor is currently located or otherwise assigned. Further, the supervisor database 138 can include information as to a particular type of trigger event(s) that is to be associated with each supervisor, including, for example, the specialty(ies) of the supervisor in terms of, for example, whether the supervisor is a law enforcement agent associated with criminal activity, an agent of a fire department associated with fires or rescue efforts, and/or medical personnel associated with attending to medical emergencies, as well as various combinations thereof, among other types of supervisors. Thus, the particular supervisor communication device 106 that is to receive the communication at block 412 can be based on a variety of different criteria, including, for example, the type of trigger event identified at block 406, as well as the information regarding the location of the identified trigger event.

Optionally, according to certain embodiments, at block 414, the response platform 102 can also generate one or more recommendations as to the type and/or location of one or more responders that can respond to the identified trigger event. The particular responders identified at block 414 can also be based on a variety of different criteria, and can be identified from information provided by the responder database 140. For example, the responder database 140 can include information that can identify a responder suggestion at block 414 based on a location proximity of the responder to the detected trigger event, as well as based on the nature of the detective trigger event, including, for example, whether the response to the trigger event should include law enforcement officers, firefighters, and/or emergency medical technicians, among others. Alternatively, according to certain embodiments, the responder database 140 can include contact information to a particular call center associated with emergencies, including, for example, numbers to emergency call centers (e.g., 911 call centers) in the vicinity of the detected trigger event.

At block 416, the response platform 102 can directly or indirectly receive a communication from the supervisor communication device 106 indicating whether the supervisor has determined a response is, or is not, to be provided to the detected trigger event. For example, in certain situations, after reviewing the information from one or more, if not all, of blocks 406, 408, 410, among other information, communicated to and/or retrieved by the supervisor communication device 106, the supervisor may determine that the identified trigger event is a training exercise, and/or the identified object at block 406 is being carried out by authorized personnel, including, for example, law enforcement personnel and/or security team members. In the event of a rejection from the supervisor, dataflow being acquired by the response platform 102 and/or being sent to at least the responder communication device 106 can cease, and the information captured or otherwise obtained in connection with the trigger event, as well the supervisor rejection decision and any other information provided by the supervisor, can be recorded by the feedback database 128 for used by the neural network 122 in connection with subsequent analysis and model training.

If at block 416 the supervisor decides that a response to the detected trigger event is not approved, then at block 418, then dataflow being acquired by the response platform 102 can cease, as mentioned above. However, if the supervisor decides at block 416 that a response is approved, and a corresponding signal is received by the response platform 102 from the supervisor communication device 106, then at block 420 the response platform 102 can be activated in a manner in which one or more responder communication devices 108 can receive a notification regarding the detected trigger event.

According to certain embodiments, the responder communication devices 108 receiving such notifications at block 416 can include, for example, the responder communication devices 108 of either or both individual responders and corresponding agencies or companies of such responders. Alternatively, or additionally, the response platform 102 can be configured to contact or notify one or more public or private dispatchers of a trigger event. In such situations, the dispatcher(s) can connect to agencies associate with particular responders, such as, for example, law enforcement agencies, and communication information obtained by emergency response system 100, including updates to such information as obtained in at least near real time, regarding at least the detected trigger event.

According to certain embodiments, if the response platform 102 receives information indicating that a response is to be provided to the detected trigger event, the response platform 102 can notify at least some citizens of the emergency response system 100 of the detected trigger event, including via providing a notification or display on an associated citizen communication device 103. Which citizen communication devices 104 are to receive a notification of the detected trigger event can be based on a variety of criteria, including, for example, a registered location for the citizen, as may be recorded in the citizen database 134, and/or a current location of the citizen communication device 104, as may be provided to the response platform 102 by citizen communication devices 104 and based on location system features (e.g. global positioning systems (GPS)) installed on the citizen communication devices 104. The platform system 102 can therefore generate a signal to a software application (“app.”) associated with the response network system 100 that is installed on the citizen communication devices 104 for notifying the associated citizens of the detected trigger event, including the particular location of the trigger event. Such a notification of the detected trigger event can be communication in variety of manners, including via use of the text, symbols, and/or maps, among other manners of communication. Additionally, or alternatively, citizens of the response network system 100 may be able to search, using the app., for current or historical detected trigger events, including for detected trigger events based on a location selected or inputted by the citizen.

Which responder communication devices 108, including with respect to either or both public responders and private responders, and moreover which responders receive notification of the detective trigger event at block 422 can be based on a variety of different criteria. Further, as discussed above, the responders that are to receive such notifications can include those responders for which information is stored in the responder database 140, responders whose own systems are integrated with the emergency response system 100, and/or responders who receive notification of the detected trigger event from a private dispatcher(s) having their own system that is integrated into the emergency response platform 100. Further, according to certain embodiments, the responders that are to receive a notification of a detected trigger event at block 422 can be those responders that are within a predetermined distance or range of the location of the detected trigger event. Thus, according to certain embodiments, the responder database 140 can contain location information regarding various responders, as may be communicated to the response platform 102 via the responder communication devices 108. Further, according to certain embodiments, such location information provided to the response platform 102 can be location information obtained using a location system (e.g., GPS) feature installed on the responder communication device 108. Additionally, or alternatively, the location information for the responder can correspond to an area or location at which each responder is assigned. The responders selected at block 422 can also be based on an identification of a specialty type(s) of the responders (e.g., law enforcement, fire fighter, emergency medical technician) and the corresponding identify type of detected trigger event.

Optionally, according to certain embodiments, in connection with the supervisor deciding at block 416 that a response is to be provided by responders, the supervisor may also accept, reject, modify, and/or supplement, the responder suggestion provided by the response platform 102 at block 414. In certain instances, the supervisor may, via the supervisor communication device 106, communicate to the response platform 102 an identification of the particular responders that are to be notified of the trigger event. Alternatively, by default, the response platform 102 can identify the responder communication devices 108 that are to receive notification of the trigger event based at least on a location of the responders relative to the trigger event and/or the identified type of trigger event, including, for example whether the trigger event involves a medical emergency, detection of a weapon, or detection of a fire, among other types of trigger events.

In connection with the responder communication devices 108 receiving a notification of the trigger event, the responder communication devices 108 can, at block 424, also receive information, including, for example, information similar to that identified at one or more of blocks 406, 408, and/or 410 that provide details. Such received information can include, for example, details pertaining to the detected trigger event, including, for example, the object, behavior, and/or event detected by the response system 102, the location of the trigger event, and one or more captured images, among other information. Additionally, the information provided to the responder communication device(s) 108 at block 424 can include one or more three-dimensional models 201, 301 of the involved area(s), including, for example, building, as well as and identification of the specific location within or outside of the building, among other structures, at which the trigger event was detected. Additionally, the information provided a block 424 can also be updated such that the responder communication device 108 can receive updated information in near real time. Thus, for example, with respect to the individual 204, 204′ or boundaries 208 shown n the model 201 illustrated in FIGS. 2, 5, 6, and 7, changes in the position of the individual 204, 204′, or to boundaries 208, can be reflected in the updated model 201 displayed on at least the display 146c of an associated responder communication device 108.

As illustrated in at least FIGS. 2 and 6, the information displayed on the display 146c of the responder communication device 108 can include a variety of other information, including, for example, a first legend 212 (FIG. 2) of a time lapse since the trigger event occurred and/or was detected, and/or indicating, which, or which type, of responder(s) has been notified of the trigger event. Additionally, or optionally, a second legend 214 can also provide additional details regarding the trigger event, including, for example, whether a current, precise location or identity of an individual(s) associated with the trigger event is known. Additionally, or optionally, a third legend 216 can include an identification of which camera 202 of the camera system 132 currently is, and/or was, detecting the presence of the trigger event and/or associated individual(s).

At block 426, the response platform 102 can determine whether the event associated with the detected trigger event has been resolved, including, for example, resolved by the responders. Additionally, according to certain embodiments, the response platform 102 can monitor and/or receive information inputted into the responder communication device 108, including, for example, typed or verbally stated, that can provide an indication as to whether the circumstances associated with the trigger event have been resolved or concluded. If the response platform 102 determines that the event has not yet been resolved, then the response platform 102 can continue to provide near real time information, including information that is continuing to be captured by the one or more cameras 202 and/or derived by the platform system 102, to the responder communication device 108 at block 424.

Upon the response platform 102 determining at block 426 that the event has been resolved, or in response to a supervisor determining at block 416 that a response to the detected trigger event is to not be provided, at block 428 the platform system 102 can record information regarding the detect the trigger event, supervised response, and or corresponding actions by one or more responders at block 428. The information obtained at block 428 can be recorded by the feedback database 128 of the platform system 102, and be used by the neural network 124 to continue to train, or retrain, the one or more models developed by the neural network 124. Thus, to the extent the information provided to the feedback database 128 results in a modification or retraining of one or more of the models developed by the neural network 124, such an update or change to the one or more models can be recorded by the platform system at block 430, and any associated incident file associated with the trigger event can be closed at block 432.

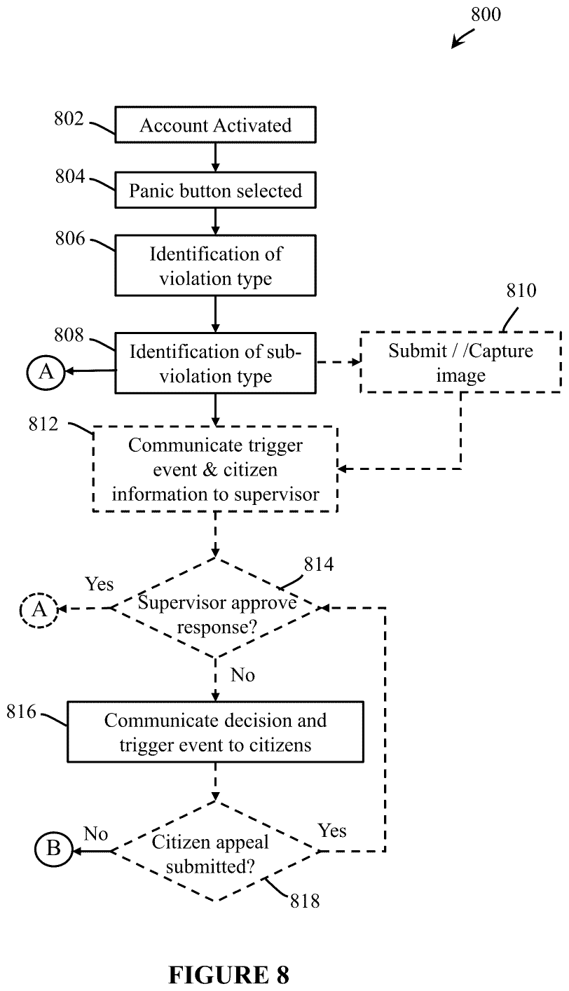

FIG. 8 illustrates a simplified exemplary representation of a method 800 for an operation of the emergency response system 100 in response to a citizen communicating information regarding a potential trigger event. The method 800 corresponds to, or is otherwise associated with, performance of the illustrative sequence shown in, and described in connection with, FIG. 8, and can be carried out, for example, by the exemplary emergency response system 100 shown in FIG. 1, including, for example, via use of one or more of the processors 114, 144a, 144b, 144c executing instructions stored on one or more associated memory devices 116. It should be appreciated, however, that the method 800 can be performed in one or more sequences different from the illustrative sequence. Additionally, the method 800 mentioned below can include steps or processes other than, or in addition to, those discussed below.

Unlike the method 400 discussed above with respect to FIG. 4, the method 800 shown in FIG. 8 can be triggered by a communication received from a citizen communication device 104, including, for example, via use of the above-mentioned app. stored on the citizen communication device 104. For example, as illustrated, according to certain embodiments, at block 802 a citizen can activate the app., and thus the associated citizen account, via, for example, using the I/O device 148a to enter user information corresponding to the particular citizen seeking to use the app. For example, at block 802, a citizen can activate the app. on the citizen communication device 104, or otherwise access the response platform 102, by entering a username and password, among other information.

With the app. activated on the citizen communication device 104, and/or the citizen otherwise having access to the response platform 102, the citizen can have access to a graphical user interface (GUI) that can include one or more panic buttons and/or selectable options indicating a detection by the citizen of one or more trigger events in the form of a potential violation(s). Such potential violations can include, for example, potential violations of the law or events that may involve detection of an object by the citizen (e.g., witnessing a possible unlawful possession of weapon; witnessing violent actions; etc.), and safety and/or medical concerns, including, but not limited to, behaviors of others, medical emergencies, or fires, among other types of events. According to certain embodiments, the selection of the panic button can include, or involve, an identification of a particular type of violation, as indicated by block 806.

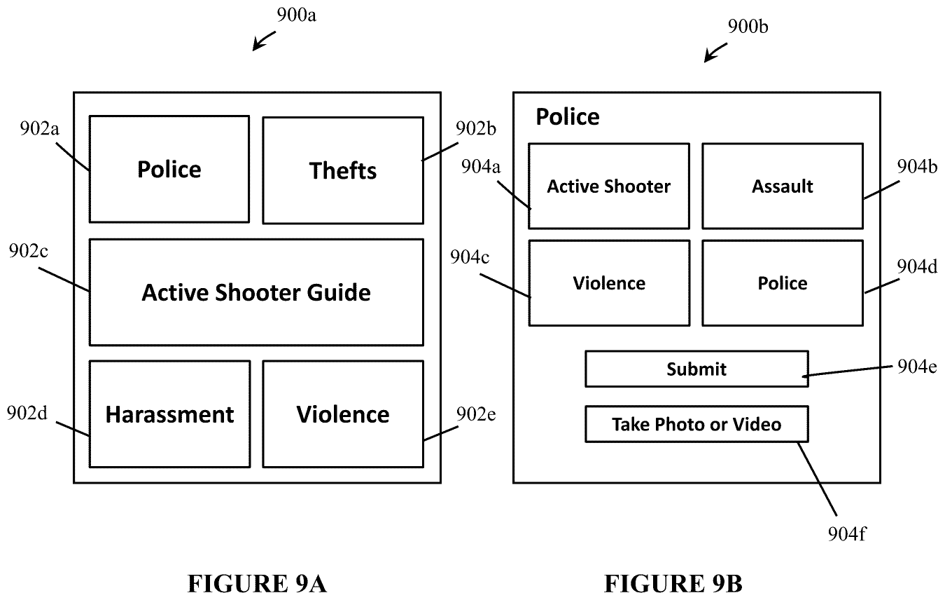

For example, FIG. 9A illustrates a first GUI 900a providing plurality of icons 902a-e relating to various violation types that may be selected by the citizen using the citizen communication device 104 and in connection with communicating a potentially dangerous or hazardous situation to at least the response platform 102. The violation types represented by the exemplary icons 902a-e, as well as the combination of violation types, shown on the first GUI 900a can vary. For instance, FIG. 9A illustrates an example in which the violation types shown by the icons 902a-e on the first GUI 900a include: a first violation type icon 902a that may generally require a response or intervention by a police officer(s); a second violation icon 902b that may involve a theft or robbery; a third violation type icon 902c involving an active shooter; a fourth violation type icon 902d that may involve harassment; and, a fifth violation type icon 902e that may involve violence.

The method 800 shown in FIG. 8 is depicted as including optional steps relating to attaining supervisory approval with respect to providing a response to a reported violation. With respect to at least certain embodiments of the illustrated method 800 that include supervisory review, the particular violation type icon 902a-e selected by the citizen using the first GUI 900a can assist in at least identifying the particular supervisor that is to evaluate the citizen's report of a violation. Additionally, the particular violation type icon 902a-e selected by the citizen can also assist in identifying at least potential responders for the violation. According to certain embodiments, information regarding the violation type identified by the citizen can further be identified by the app. and/or response platform 102 seeking additional information from the citizen. For example, referencing FIG. 9B, according to certain embodiments, in response to an identification of a particular violation type via a selection of a particular icon 902a-e shown on the first GUI 900a, the app. and/or response platform 102 can provide a second GUI 900b for display on the citizen communication device 104. The second GUI 900b can provide various icons 904a-d of sub-violations relating to the specific violation type the citizen selected using the first GUI 900a. For example, in the illustrated example shown in FIGS. 9a and 9b, in response to the citizen selecting the first violation type icon 902a (e.g., “Police”) at the first GUI 900a displayed on the citizen communication device 104, the app. and/or platform system 102 can facilitate a display on the citizen communication device 104 of a second GUI 900b. As shown in FIG. 9b, in this example the second GUI 900b displays for citizen selection a plurality of sub-violation type icons 904a-d relating to the selected first violation type 902a (e.g., “Police”). Moreover, in the illustrated example, the sub-violation type icons 904a-d associated with the selected first violation type 902a (e.g., “Police”) can include: a first sub-violation type icon 904a associated with a reporting of an active shooter; a second sub-violation type icon 904b associated with a reporting of an assault; a third sub-violation type icon 904c associated with a reporting of violence; and a fourth sub-violation type icon 904c associated with another request for a police response.

Optionally, as indicated by block 810 in FIG. 8 and the selection icon 904e shown in FIG. 9b, in an at least certain situations, the second GUI 902a, among other GUIs provided by the app. and/or response platform 102, can provide an option for the citizen to capture and/or submit an image of the violation being reported. Such an image can the one or more photographs and/or videos that can be captured, for example, by the camera 150a of the citizen communication device 104.

The violation/sub-violation types identified by the citizen at blocks 806 and 808, as well as any image submitted by the citizen at block 810, can be communicated to the response platform 102, such as, for example, in response to the citizen selecting a submit icon 904e on the second GUI 900b. Additionally, according to certain embodiments, the information provided by the citizen communication device 104 can also include location information, which may be manually entered by the citizen using the I/O device 148a and/or provided by location information from the citizen communication device 104, such as, for example, from a location system (e.g., GPS) feature of the citizen communication device 104.

With respect to embodiments that include the optional supervisory review feature, at block 812, the response platform 102 can utilize the information provided at blocks 806, 808, 810, as well as information provided by the supervisor database 138 to identify a supervisor communication device 106 to which information regarding the reported trigger event, as reported by the citizen, can be communicated for supervisory review. For example, in instances in which a citizen reports a trigger event in the form of a potential violation involving an individual being seen in possession of a firearm, information acquired at least at blocks 806, 808, and 810 can be provided to a supervisor at block 812 for a decision as to providing a response by responders is, or is not, approved. In other instances, based on the nature of the trigger event, such as, for example, witnessing a forest fire, such supervisory review by a supervisor may not be sought, and instead the reported violation can instead be communicated by the response platform to responders, or associated public or private dispatchers.

In situations in which the trigger event (e.g., violation reported by the citizen) is to be communicated to a supervisor, the particular supervisor communication device 106, and thus the particular supervisor, that is to receive and/or retrieve the information, or associated notification of the availability of the information, at block 812 can be determined in a manner similar to that discussed above with respect to at least block 412 of the method 400 shown in FIG. 4.

Additionally, or alternatively, to the extent a reported violation is communicated for supervisory approval, the information provided by the response platform 102 to, or otherwise retrievable by, the supervisor communication device 106 can include additional information relating to the particular citizen that is reporting the violation. For example, according to certain embodiments, the information communicated to, or retrievable by, the supervisor communication device 106 can include health information relating to the citizen, which may be of particular use in situations involving potential medical emergencies. The provided or retrievable information can also include historical information relating to past violation reports received from the citizen, as well as past supervisor decisions with respect to those reports, including past decisions as to whether to, or not to, send responders in response to the past violation(s) reported by the citizen and the outcome of such responses by responders to those reports. Alternatively, according to embodiments that do not include supervisory review features, such above-discussed information regarding the citizen that is reporting the violation can also be communicated to, or otherwise retrievable by one or more of the responder communication devices 108 that are to receive a notification of the trigger event, as discussed below, and/or associated dispatchers that notify can notify the responders, including associated agencies or companies, of the reported violation.

Similar to the information generated at block 414 of the method 400 shown in FIG. 4, to the extent supervisory review features are utilized, the information communicated to, or retrieved by, the supervisor communication device 106 at block 812 can, according to certain embodiments, also include an identification of a suggestion of one or more responders, as generated by the response platform 102, including via model trained using the neural network 124, for responding to the asserted violation. Thus, for example, the response platform 102 can be configured to identify, using at least information regarding the location of the reported violation and violation/sub-violation type(s), among other information, and a trained model(s), including one or more algorithms, one or more responders from the responder database 140 that may be deployed to respond to the reported violation. For example, in certain situations involving an active shooter, the response platform 102 may suggest that the response platform 102 notify either or both a particular law enforcement agency and SWAT team, among others, of the detected shooter.

Using at least the information provided to the supervisor communication device 106 at block 812, a supervisor can decide whether a response to the reported violation is to, or is not to, be provided by responders. Thus, the decision by the supervisor that block 814 can be similar to that discussed above with respect to block 416 of the method 400 shown in FIG. 4. Accordingly, if the response platform 102 receives a signal from the supervisor communication device 106 indicating that the supervisor has decided at block 814 that a response by responders is to be provided to the reported violation, then the method 800 can proceed in a manner similar to that discussed above with respect to blocks 420 through 432 in FIG. 4. Additionally, if the supervisor decides a response is to be provided by the responders, citizens of the response network system 100 can receive a notification of the reported violation, including the location of the reported violation, in a manner similar to that discussed above with respect to the method 400 shown in FIG. 4 and citizen notification of a detected trigger event.

Alternatively, with respect to embodiments that do not incorporate supervisory review, in response to obtaining information from any one, or any collection, of blocks 806, 808, and 810 the method 800 can proceed in a manner similar to above with respect to blocks 420 through 432 in FIG. 4.

Optionally, according to certain embodiments in which the method 800 includes features relating to supervisory review, if the response platform 102 receives a signal from the supervisor communication device 106 indicating that the supervisor has decided at block 814 that a response by responders is not to be provided to the reported violation, then, according to certain embodiments, the response platform 102 can at block 816 provide a notification of the denial of the supervisor to the citizen communication device 104. In such situations, the app. and/or response platform 102 may provide an option for a citizen to appeal the decision of the supervisor. Such an appeal option can include options for the citizen to provide, via of the citizen communication device 104, updated and/or additional information or details regarding the asserted violation, including updated images, as generally indicated by block 818. According to such an embodiment, the response platform 102 can generate a communication to the supervisor communication device 106 regarding the appeal of the citizen, and include any additional received by the response platform 102 from the citizen communication device 104. The supervisor can then be provided an opportunity again at block 816 review the appeal and/or additional information before making another decision as to whether to deploy responders for the reported violation. The response platform 102 can also be configured to set a predetermined limit on the number of appeals the response platform 102 can receive regarding a supervisory denial of the reported violation before terminating any further review or associated response to the reported violation.

If, however, a citizen does not appeal the decision of the supervisor to not send responders to address the reported violation, then the method 800 can proceed in a manner similar to that discussed above with respect to blocks 420, 428, 430, and 432 of the method 400 shown in FIG. 4.

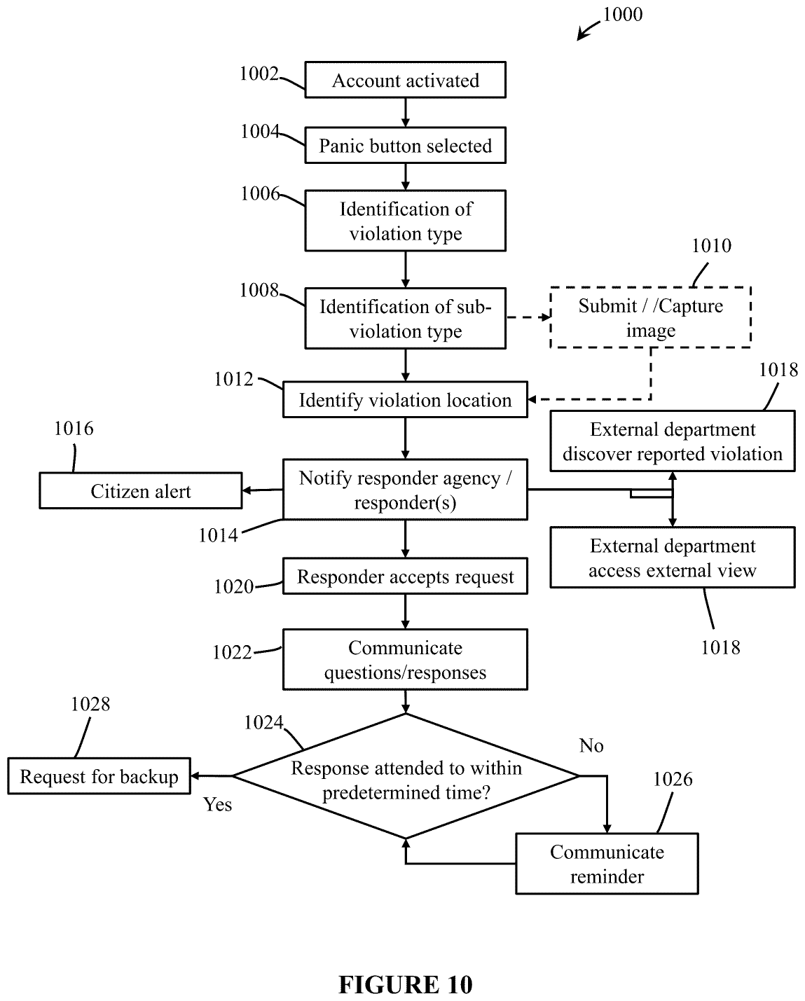

FIG. 10 illustrates a simplified exemplary representation of another embodiment of a method for an operation of the emergency response system 100 in response to a citizen communicating information reporting a violation. The method 1000 corresponds to, or is otherwise associated with, performance of the illustrative sequence shown in, and described in connection with, FIG. 10, and can be carried out, for example, by the exemplary emergency response system 100 shown in FIG. 1, including, for example, via use of one or more of the processors 114, 144a, 144b, 144c executing instructions stored on one or more associated memory devices 116. It should be appreciated, however, that the method 1000 can be performed in one or more sequences different from the illustrative sequence. Additionally, the method 1000 mentioned below can include steps or processes other than, or in addition to, those discussed below.

At block 1002, a citizen can activate an associated citizen account that is already registered, or is in the process of being registered, with the emergency response system 100. For example, with respect to the previously discussed app. that may be installed on the citizen communication device 104, or with respect to attempts to access features of the system 100 via use of a web-based platform, the citizen can input or enter associated credentials, including, for example, a username and/or a password to gain access to at least certain features of emergency response system 100.

In response to activation of the citizen's account, one or more GUIs or webpages, including, for example, the GUIs 900a, 900b shown in FIGS. 9A and 9B, among other GUIs or webpages, can be displayed on the display 146a of the citizen communication device 104. While FIGS. 9A and 9B depict simplified representations of examples of possible GUIs 900a, 900b that may be presented to citizens, the configuration and content of the particular GUIs and/or webpages that are accessible to citizens, supervisors, and responders, among others having access to the emergency response system 100, can, for each of the embodiments discussed herein, be dynamically adjustable, including, with respect to the content, layout, icons, colors, menus, and/or selectable features, among other attributes, provided by the GUIs and/or webpages. Additionally, different GUIs and/or webpages may be accessible for the different groups (e.g., citizens, supervisors, and responders, among others), and may also be different for different members within each of the groups. For example, according to certain embodiments, the GUIs and/or webpages that are accessible to citizens may differ from that available to supervisors and responders. Further, the GUIs and/or webpages that are accessible to some citizens, including, for example, citizens that are deemed novice users of the system 100, may be different than the GUIs and/or webpages that are accessible to more experienced users. Additionally, the GUIs and/or webpages accessible to supervisors and responders can vary with respect various criteria, including, for example, the identified specialties of the supervisors and responders. Thus, the design of the GUIs 900a, 900b can be based on dynamic settings from the administrative side of the emergency response system 100, which can accommodate selective and dynamic modification of the GUIs 900a, 900b, including with respect to the designs of the GUIs 900a, 900b and the selectable features or action keys.

Additionally, for each of the embodiments discussed herein, the GUIs and/or webpages that are accessible to citizens, supervisors, and responders may provide one or more sections that can accommodate a display of one or more advertisements. Further, the configuration of such displayed advertisements can be dynamically adjustable by administrators of the emergency response system 100, including with respect to the location, size, and/or color, among other features, of such displayed advertisements.

Continuing with the method 1000 depicted in FIG. 10, with the citizen account activated, the citizen can utilize the citizen communication device 104 to report, at block 1004, a detected trigger event, including, for example, a trigger event in the form of a violation witnessed by the citizen. The citizen communication device 104 used for such reporting can be a single citizen communication device 104, such as, for example, a smartphone, or involve a plurality of citizen communication devices 104, such as, for example, reporting a violation using an interface of a smartwatch that is communicatively coupled to a smartphone that is running the app. of the system 100. According to embodiments that can utilizer smartwatches or other wearable technology, the wearable technology can provide an enhanced level of security measures, as well as provide citizens with an additional layer of safety. Moreover, by leveraging wearable technology, citizens can trigger an emergency alert with simplified two-step actions, enabling accurate location tracking without relying solely on a smartphone.

As indicated by blocks 1004 and 1006, similar to blocks 806 and 808 in FIG. 8, the citizen can have access to the first and/or second GUI 900a, 900b (FIGS. 9A and 9B) to identify a violation type, as generally represented by the exemplary icons 902a-e in FIG. 9A, and/or a sub-violation type, as generally represented by the exemplary icons 904a-d shown in FIG. 9B. Moreover, the citizen can utilize the first GUI 900a to select a violation from a collection of predefined violations presented by the GUI 900a, and then, based on that selected predefined violation, be presented with related predefined sub-violations for selection. Such predefined listings of violations and sub-violations, as provide by the GUI 900a, 900b, or an associated webpage, can provide a panic button list, which can facilitate relatively fast reporting by the citizen of the identified violation to the response platform 102.

Alternatively, or additionally, similar to block 810 of the method 800 shown in FIG. 8, the method 1010 can further include captured information obtained by the citizen being communicated from the citizen communication device 104 to the response platform 102. If the citizen includes captured information for the response platform 102 at block 1010, the citizen may also have the option to submit, via use of the citizen computing device 104, information for submission to the response platform 102 describing the violation/sub-violation the citizen is reporting, and/or provide details of what is shown in the captured information being provided by the citizen.

Additionally, at block 1012, the citizen can report, and/or the location features of the citizen communication device 104 can be utilized to identify, to the response platform 102 a location of the reported violation and/or sub violation.

At block 1014, the response platform 102 can identify, including alert, one or more responders, including, associated agencies of the responders, of the reported violation. According to certain embodiments, the alert provided at block 1014 can be in the form of a request seeking one or more of the notified responders to evaluate and/or respond to the reported event. Additionally, or alternatively, according to certain embodiments, as previously discussed, such an alert or notification to the responders can include the response platform 102 notifying a dispatcher who in turn communicates an alert of the reported violation to one or more identified responder(s).

The particular responders that may receive the notification of the reported violation at block 1014 can be based on a variety of different types of criteria. For example, according to certain embodiments, the responders notified of the reported violation can include, for example, responders identified as having a specialty that corresponds to the type or nature of reported violation. Further, the notified responders can be responders that are a location, including, for example, a current location, that is within a predetermined distance of the location identified for the reported violation, as provided at block 1012. For example, with respect to a reported violation that may require the response from a law enforcement officer, at block 1016 the response platform 102 may notify police officers identified in the responder database 140 that are within a predetermined distance or range from the location of the reported violation.

Optionally, according to certain embodiments, at block 1016, citizens that participate in the emergency response system 100 can also receive notifications of reported violations, or of at least notifications for certain types of reported violations. Such notifications to such citizens that did not report the violation, also referred to as peripheral citizens having citizen communication devices that can also be referred to herein as peripheral having citizen communication devices, can be provided to, or accessible by, the citizen communication device 102 in a variety of different manners. For example, according to certain embodiments, the app. associated with the emergency response system 100 that may be installed on the citizen communication device 104 may be able to retrieve a map or model similar to the three-dimensional model 301 shown in FIG. 3, among other map formats. According to such an embodiment, the app. can be configured to provide an indication, or otherwise reveal, a location of one or more reported violations. Again, however, the types of violations that may be viewable by citizens using the app. maybe limited to certain situations or be identified as being part of a predefined category of relative dangerous or hazardous violations, such as, for example, reported violations involving natural disasters (e.g., flooding, cold waves, drought, earthquakes, hail, heat waves, hurricanes, and wildfires), active shooters, terrorist activities, and/or outbreaks and epidemics.

Additionally, at block 1016, the app. can be configured to override at least certain notification settings on the citizen communication device 104 that may otherwise be set to silence alerts or other noises. By overriding such notification settings, or other similar settings, the app. can provide the ability for such peripheral citizens to receive audible alerts for at certain types violations that the response platform 102 has identified as being within, or satisfying, one or more predefined categories of relatively dangerous or hazardous types of violations, including, for example, violations relating to relatively dangerous situations, including, for example, violations related to mass shootings, wildfires, or family emergencies. Further, according to certain embodiments, at block 1016, the app. can also be configured to provide a full-screen alert wherein, for at least certain types of relatively dangerous violations, generally the entire display 146a of the citizen communication device 104 can display an alert.

An occurrence of a receipt by the response platform 102 of a reported violation can also be discovered, at block 1018, by other responders, agencies, or entities, generally referred to herein as external departments, that were not notified at block 1016 of the reported violation. For example, while notifications can be sent by the response platform 102 to certain, identified responders at block 1016, external departments may have to take actions to proactively discover reported violations, such as, for example, via accessing an external department portal that may be provided on webpage supported by the response platform 102. The external departments may, for at least some reported violations, have to discover reported violations at block 1018, rather than receiving a notification at block 1016, for a variety of reasons. For example, the external departments may not qualify to be a responder for reported violations that occur at a location that is beyond a predetermined threshold distance from the external department. Additionally, or alternatively, an external department may not qualify as a responder when the nature of the violation does not correspond to an identified specialty of the external department but qualify to receive information regarding the reported violation if the external department is within a predetermined distance from the location of the reported violation. For example, a fire department at a particular location may only receive alerts intended for responders at block 1016 if the reported violation is associated with the fire department's area of expertise, such as, for example, relates to a fire, and the reported fire is within a predetermined distance from the fire department. However, in the event such criteria is not satisfied, and the fire department therefore does not qualify to receive such alerts at block 1016, the fire department can still discover information regarding the reported violation by logging into the emergency response system 100 (such as, for example, via entering a valid username and password), and discovering the reported violation at a corresponding external department portal.

Additionally, or alternatively, at block 1018, external departments can, via access to one or more maps or models provided by the response platform 102, including, for example, stored in the model database 136, view an area around a location of a reported violation. For example, a map or model similar to that shown in at least FIG. 3 can be provided by the response platform 102 as an interactive map that can include features that can facilitate personnel at external departments investigating an area at a location at which a reported violation is located. According to certain embodiments, such interactive features can include selectable icons or other features that can be used to adjust a point of view(s) provided by the interactive map, including with respect to allowing the viewer(s) of the interactive map move around different locations represented by the map, change zoom levels, and/or adjust views at different locations about the interactive map, including with respect to portions of the interactive map that are represent the location of the reported violation. Such manipulation of the map can allow personnel of the external department to identify various features, and feature locations, that can be communicated to responders so as to assist with the responders' efforts with addressing the reported violation. For example, by being able to manipulate the interactive map, personnel of the external department can identify, in advance of the arrival of responders to the location of the reported violation, the locations of exits and entrances to a facility or location at which the reported violation occurred. Such advance scouting of an area in question can be tactically beneficial with respect to at least planning or coordinating subsequent actions of the responders.

As also seen in FIG. 10, at block 1020, a responder that received the notification of the reported violation, may, via use of the responder communication device 108, provide a response to the response platform 108 indicating the responder will accept a request to respond to the reported violation. According to certain embodiments, the emergency response system 100 can be configured to grant patrol officers permission to use, including receive and send communications to/from other portions of the system 100, from a location inside of a patrol vehicle via a responder communication device 108 in the form of a laptop inside each patrol vehicle, while all of the patrols, either in vehicles or on foot, bike, or motorcycle, are being tracked by the system 100 to ensure logistical outreach.

Once the reported violation is accepted by the responder, the response platform 102 can, at block 1022, generate a signal to facilitate a display of a list of predefined questions that can be displayed on the display 146a of the citizen communication device 104. Additionally, the response platform 102 can be configured to provide a predetermined list of selectable answers to the predefined questions. Such an approach of having predefined questions, and the associated options for selectable answers, can be beneficial at least in terms of minimizing time associated with inputting answers to the questions. Further, the predefined questions and selectable answers can be provided in different languages, which can also minimize potential language barriers.

After, or within a predetermined time after, the responder has accepted a request to respond to the reported violation at block 1020, the response platform 102 and/or an app. on the responder communication device 108, can initiate a timer. The timer can be used to track whether the responder has attended to the reported violation, including, for example, has arrived at the reported location of the violation, within a predetermined time. If the response platform 102 and/or app. on the responder communication device 108 determines that the respondent has not attended to the reported violation within the predetermined time period, the response platform 102 and/or app. on the responder communication device 108 can, at block 1026, communicate a reminder communication to the responder, such as, for example, via an audible or text alert being communicated at the responder communication device 108. Additionally, such a reminder communication at block 1026 can be repeatedly communicated at regular or irregular intervals for a predetermined number of times, until the response platform 102 and/or responder communication device 108 has received information indicating the responder has addressed the reported violation, and/or the responder has silenced such reminder communications.

Additionally, as indicated at block 1028, according to certain embodiments, the response platform 102 can be configured to receive requests for backup assistance from one or more of the responders that accepted a request to respond to the reported violation (block 1020). In response to receipt of such a request for backup, the response platform can be configured to communicate a request for assistance to other responders that may be within a predetermined vicinity of the location of responder(s) seeking the assistance, and/or of the location of the reported violation. One or more of the other responders receiving the request or alert for assistance can have the option to accept or ignore the request. Further, the request for assistance can be accepted by multiple responders.

According to certain embodiments, the emergency response system 100 can have live map features that can enable administrators of the agencies, departments, or organizations (collectively generally referred to as departments) that use the system 100, to have a centralized control panel that can serve as the nerve center for the actions of those departments. Such a control panel feature can be configured to allow such administrators to oversee the at least near real-time progress of activities of the personnel of those departments, including, for example, with respect to monitoring and detecting violations, and as well as with respect to ongoing operations. Such a control panel can further provide a dynamic view of activities, and can focuses primarily, if not solely, on at least near real-time data, emphasizing the geographical aspect of operations and maintaining live connections with ongoing operations. Accordingly, within the view provided by the control panel, administrators can gain access to a comprehensive list of checked-in officers, pending and accepted violations, and pending and accepted detections. Additionally, the control panel can provide an interface that displays a map populated with pinned locations of officers, violations, and detections, offering a visual representation of these elements for quick and efficient monitoring.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. An emergency response system comprising:
one or more databases that receive a neural network training data corresponding to a plurality of characteristics for each of a plurality of historical trigger conditions;
at least one processor; and
a memory device coupled to the at least one processor, the memory device including instructions that when executed by the at least one processor cause the at least one processor to:
analyze, for continuous training of a neural network based on machine learning, the neural network training data to identify one or more trigger event characteristics corresponding to one or more of the plurality of historical trigger conditions;
detect, using the neural network, an occurrence of a trigger event based at least on a detection of the one or more trigger event characteristics in one or more captured images;
generate, in response to the detection of the one or more trigger event characteristics, a signal to communicate the detection of the trigger event to at least one supervisory communication device; and
generate, after communication of the detection of the trigger event to at least one supervisory communication device and in response to a receipt of an approval signal from the at least one supervisory communication device, a notification to at least one responder communication device, the approval signal having an indication of an approval by a supervisor of at least one responder being deployed to respond to the trigger event.

2. The emergency response system of claim 1, further including an optical recognition system having a plurality of cameras, each of the plurality of cameras configured to capture the one or more captured images, and wherein one or more of the plurality of cameras are located at the location of the occurrence of the trigger event.

3. The emergency response system of claim 1, wherein the one or more captured images are captured by a citizen communication device, and wherein the memory device further includes instructions that when executed by the at least one processor cause the at least one processor to receive a signal containing the one or more captured images.

4. The emergency response system of claim 3, wherein the memory device further includes instructions that when executed by the at least one processor cause the at least one processor to receive a signal indicative of a selection at the citizen communication device of at least one of a violation type and/or a sub-violation type, and wherein the detection of the trigger event is further based on the selection of the violation type and/or the sub-violation type.

5. The emergency response system of claim 1, wherein the memory device further includes instructions that when executed by the at least one processor cause the at least one processor to:
generate, based at least on the one or more trigger event characteristics, an identification of the at least one responder.

6. The emergency response system of claim 1, wherein the memory device further includes instructions that when executed by the at least one processor cause the at least one processor to:
communicate a three-dimensional model of a location at which the trigger event is detected to at least one of the at least one supervisory communication device and the at least one responder communication device.

7. A method for operating an emergency response system, the method comprising:
receiving a report signal that identifies a reported violation being reported via use of a citizen communication device of a citizen, the report signal identifying, for the reported violation, at least a violation location and a violation type;
identifying a plurality of responders to respond to the reported violation, each responder of the plurality of responders being identified based at least on a responder location identified for the responder being within a predetermined distance from the violation location and an identified specialty of the responder corresponding to the violation type;
receiving a response signal from a responder communication device of at least one responder of the plurality of responders, the response signal indicating an agreement of the at least one responder to respond to the reported violation;
generating, based at least on the violation type, a query signal to communicate to the citizen communication device a plurality of predefined questions and, for each predefined question, a plurality of predefined answers; and
generating a signal to communicate to the responder communication device of the at least one responder a predefined answer from the plurality of predefined answers selected by the citizen to at least one predefined question of the plurality of predefined questions.

8. The method of claim 7, further comprising:
receiving, with the report signal, a captured image captured using the citizen communication device; and
receiving, with the report signal, a description, as inputted by the citizen using the citizen communication device, of one or more features shown in the image.

9. The method of claim 7, further comprising:
communicating the reported violation to an external department that is located within the predetermined distance from the violation location and/or has an identified specialty that does not correspond to the violation type; and
generating a signal to allow access of the external department to an interactive map stored by the emergency response system, the interactive map configured to accommodate selectable adjustment by the external department of at least a point of view displayed in the interactive map that is representative of at least the violation location.

10. The method of claim 9, further including:
dynamically adjusting, as the responder location changes, a representation of the responder location displayed on the interactive map.

11. The method of claim 7, further comprising:
communicating, if the violation type is determined to be within a predefined category of violations, an alert signal for a plurality of peripheral citizen communication devices of peripheral citizens that are within the predetermined distance from the violation location.

12. The method of claim 7, wherein the violation type identified by the report signal is selectable from a plurality of dynamically adjustable violation types displayed on a display of the citizen communication device.

13. A method for operating an emergency response system, the method comprising:
analyzing, for continuous training of a neural network based on machine learning, a neural network training data to identify one or more trigger event characteristics corresponding to one or more of a plurality of historical trigger conditions;
detecting, using the neural network, an occurrence of a trigger event based at least on a detection of the one or more trigger event characteristics in one or more captured images;
generating, in response to the detection of the one or more trigger event characteristics, a signal to communicate the detection of the trigger event to at least one supervisory communication device; and
generating, after communication of the detection of the trigger event to at least one supervisory communication device and in response to a receipt of an approval signal from the at least one supervisory communication device, a notification to at least one responder communication device, the approval signal indicating of an approval by a supervisor of at least one responder being deployed to respond to the trigger event.

14. The method of claim 13, further comprising receiving the one or more captured images from an optical recognition system having a plurality of cameras, each of the plurality of cameras configured to capture the one or more captured images, and wherein one or more of the plurality of cameras are located at the location of the occurrence of the trigger event.

15. The method of claim 13, wherein the one or more captured images are captured by a citizen communication device, and further comprising receiving a signal containing the one or more captured images.

16. The method of claim 13, further comprising receiving a signal indicative of a selection at the citizen communication device of at least one of a violation type and/or a sub-violation type, and wherein the detection of the trigger event is further based on the selection of the violation type and/or the sub-violation type.

17. The method of claim 13, further comprising generating, based at least on the one or more trigger event characteristics, an identification of the at least one responder.

18. The method of claim 13, further comprising communicating a three-dimensional model of a location at which the trigger event is detected to at least one of the at least one supervisory communication device and the at least one responder communication device.

19. The method of claim 13, further comprising generating, in response to a receipt of a denial signal from the at least one supervisory communication device, a signal that indicates the at least one responder is not to be deployed to respond to the trigger event.

20. The method of claim 13, further comprising generating, in response to receipt of the approval signal, a notification signal for one or more citizen communication devices to communicate the detection of the trigger event.
